(19) United States
(12) Patent Application Publication
(10) Pub. No.: US 2021/0163129 A1
(43) Pub. Date: Jun. 3, 2021

(54) WINGED DEVICES AND METHODS OF OPERATION

(71) Applicant: Animal Dynamics Limited, Oxford (GB)

(72) Inventors: Adrian Leland Rees THOMAS, Oxford (GB); Alexander Orlando Harold CACCIA, Oxford (GB); Kate Victoria REYNOLDS, Oxford (GB)

(21) Appl. No.: 17/072,488

(22) Filed: Oct. 16, 2020

Related U.S. Application Data
(60) Provisional application No. 62/942,497, filed on Dec. 2, 2019.

(51) Int. Cl. B64C 39/00; B64C 39/02

(52) U.S. Cl. CPC B64C 39/005; B64C 39/024; B64C 2211/00; B64C 2201/10; B64C 2201/025

(57) ABSTRACT

Described are aerial vehicle kits and aerial vehicles comprising two or more wing units that can be driven individually. Such control of the lift and propulsion generation of each wing individually enables greater vehicle control for increased maneuverability and weather tolerance.

### CROSS-REFERENCE TO RELATED APPLICATIONS

This application claims the benefit of U.S. Application No. 62/942,497, filed on Dec. 2, 2019, entitled “WINGED DEVICES AND METHODS OF OPERATION,” the contents of which are incorporated herein by reference for all purposes.

### BACKGROUND

Micro aerial vehicles (MAVs), generally known as drones, are currently used for a multitude of purposes, including reconnaissance, general surveillance, and recreational applications. One type of MAV includes a quadcopter which employs four or more propellers to generate lift and thrust. Flapping wing MAVs (FWMAVs), a type of MAV, imitates the flight characteristics of natural flying creatures by employing a flapping wing.

### SUMMARY

One aspect provided herein is a modular aerial vehicle kit comprising: a hull; and two or more modular wing units, each modular wing unit comprising: a single wing configured to generate lift, thrust, or both via a flapping motion; and an actuator actuating the single wing in the flapping motion; wherein the two or more modular wing units releasably and operably couple to the hull to form an aerial vehicle; and wherein each of the two or more modular wing units is individually controlled to alter a flight characteristic of the aerial vehicle.

In some embodiments, each of the two or more modular wing units is pivotable about the hull. In some embodiments, the two or more modular wing units releasably and operably couple to a top portion, a bottom portion, a front portion, a rear portion, a side portion, or any combination thereof of the hull. In some embodiments, the two or more modular wing units releasably and operably couple to the hull without the use of tools. In some embodiments, the two or more modular wing units releasably and operably couple to the hull in less than about 10 minutes. In some embodiments, the actuator comprises a motor, a solenoid, a spring, a piston, or any combination thereof. In some embodiments, the actuator individually actuates and controls only one single wing. In some embodiments, the actuator actuates the single wing via a linkage. In some embodiments, the actuator directly actuates the single wing. In some embodiments, the actuator actuates the single wing in the flapping motion by controlling a flapping velocity, a flapping amplitude, a flapping angle, or any combination thereof of the single wing. In some embodiments, the actuator operates in a sinusoidal waveform profile, a square waveform profile, a hybrid sinusoidal-square waveform profile, or any combination thereof. In some embodiments, the flapping motion comprises an oscillating motion, a continuous rotation, or both. In some embodiments, the flapping motion has a sinusoidal waveform profile, a square waveform profile, a hybrid sinusoidal-square waveform profile, or any combination thereof. In some embodiments, the flapping motion is at or near a resonance frequency of the single wing. In some embodiments, the two or more modular wing units flap their single wings in an out-of-phase mode and an in-phase mode. In some embodiments, the two or more modular wing units flap their single wing in the out-of-phase mode for a first duration and in the in-phase mode for a second duration. In some embodiments, a first portion of the two or more modular wing units flap their single wings in the out-of-phase mode, and wherein a second portion of the two or more modular wing units flap their single wing in the in-phase mode. In some embodiments, the flight characteristic comprises a roll, a pitch, a yaw, or any combination thereof of the aerial vehicle. In some embodiments, the modular wing unit further comprises an energy recovery unit coupled to the actuator, the single wing, or both. In some embodiments, the energy recovery unit imparts a returning force on the single wing towards a center point of the flapping motion. In some embodiments, the energy recovery unit generates lift and improves an operational efficiency of the modular wing unit. In some embodiments, the modular aerial vehicle kit further comprises a controller directing the actuator of each of the two or more modular units.

Another aspect provided herein is an aerial vehicle comprising: a hull; and two or more modular wing units, each modular wing unit releasably and operably coupled to the hull and comprising: a single wing configured to generate lift, thrust, or both via a flapping motion; and an actuator actuating the single wing in the flapping motion; wherein each of the two or more modular wing units is individually controlled to alter a flight characteristic of the aerial vehicle.

In some embodiments, each of the two or more modular wing units is pivotable about the hull. In some embodiments, the two or more modular wing units releasably and operably couple to a top portion, a bottom portion, a front portion, a rear portion, a side portion, or any combination thereof of the hull. In some embodiments, the two or more modular wing units releasably and operably couple to the hull without the use of tools. In some embodiments, the two or more modular wing units releasably and operably couple to the hull in less than about 10 minutes. In some embodiments, the actuator comprises a motor, a solenoid, a spring, a piston, or any combination thereof. In some embodiments, the actuator individually actuates and controls only one single wing. In some embodiments, the actuator actuates the single wing via a linkage. In some embodiments, the actuator directly actuates the single wing. In some embodiments, the actuator actuates the single wing in the flapping motion by controlling a flapping velocity, a flapping amplitude, a flapping angle, or any combination thereof of the single wing. In some embodiments, the actuator operates in a sinusoidal waveform profile, a square waveform profile, a hybrid sinusoidal-square waveform profile, or any combination thereof. In some embodiments, the flapping motion comprises an oscillating motion, a continuous rotation, or both. In some embodiments, the flapping motion has a sinusoidal waveform profile, a square waveform profile, a hybrid sinusoidal-square waveform profile, or any combination thereof. In some embodiments, the flapping motion is at or near a resonance frequency of the single wing. In some embodiments, the two or more modular wing units flap their single wings in an out-of-phase mode and an in-phase mode. In some embodiments, the two or more modular wing units flap their single wing in the out-of-phase mode for a first duration and in the in-phase mode for a second duration. In some embodiments, a first portion of the two or more modular wing units flap their single wings in the out-of-phase mode, and wherein a second portion of the two or more modular wing units flap their single wing in the in-phase mode. In some embodiments, the flight characteristic comprises a roll, a pitch, a yaw, or any combination thereof of the aerial vehicle. In some embodiments, the modular wing unit further comprises an energy recovery unit coupled to the actuator, the single wing, or both. In some embodiments, the energy recovery unit imparts a returning force on the single wing towards a center point of the flapping motion. In some embodiments, the energy recovery unit generates lift and improves an operational efficiency of the modular wing unit. In some embodiments, the aerial vehicle further comprises a controller directing the actuator of each of the two or more modular units.

Another aspect provided herein is an aerial vehicle kit comprising: a hull; two or more modular wing units, each modular wing unit comprising: an actuator; and a wing actuated by the actuator in a flapping motion to propel the hull; and a flight controller individually controlling the actuator of each of the two or more modular wing units; wherein the two or more modular wing units releasably and operably couple to the hull.

In some embodiments, each of the two or more modular wing units is pivotable about the hull. In some embodiments, the two or more modular wing units releasably and operably couple to a top portion, a bottom portion, a front portion, a rear portion, a side portion, or any combination thereof of the hull. In some embodiments, the two or more modular wing units releasably and operably couple to the hull without the use of tools. In some embodiments, the two or more modular wing units releasably and operably couple to the hull in less than about 10 minutes. In some embodiments, the actuator comprises a motor, a solenoid, a spring, a piston, or any combination thereof. In some embodiments, the actuator individually actuates and controls only one single wing. In some embodiments, the actuator actuates the single wing via a linkage. In some embodiments, the actuator directly actuates the single wing. In some embodiments, the actuator actuates the single wing in the flapping motion by controlling a flapping velocity, a flapping amplitude, a flapping angle, or any combination thereof of the single wing. In some embodiments, the actuator operates in a sinusoidal waveform profile, a square waveform profile, a hybrid sinusoidal-square waveform profile, or any combination thereof. In some embodiments, the flapping motion comprises an oscillating motion, a continuous rotation, or both. In some embodiments, the flapping motion has a sinusoidal waveform profile, a square waveform profile, a hybrid sinusoidal-square waveform profile, or any combination thereof. In some embodiments, the flapping motion is at or near a resonance frequency of the single wing. In some embodiments, the two or more modular wing units flap their single wings in an out-of-phase mode and an in-phase mode. In some embodiments, the two or more modular wing units flap their single wing in the out-of-phase mode for a first duration and in the in-phase mode for a second duration. In some embodiments, a first portion of the two or more modular wing units flap their single wings in the out-of-phase mode, and wherein a second portion of the two or more modular wing units flap their single wing in the in-phase mode. In some embodiments, the modular wing unit further comprises an energy recovery unit coupled to the actuator, the single wing, or both. In some embodiments, the energy recovery unit imparts a returning force on the single wing towards a center point of the flapping motion. In some embodiments, the energy recovery unit generates lift and improves an operational efficiency of the modular wing unit. In some embodiments, the kit further comprises a controller directing the actuator of each of the two or more modular units. In some embodiments, the flight controller individually controls the motors of the two or more modular wing units in: an in-phase wing flapping mode; an out-of-phase wing flapping mode; a sequential wing flapping mode; a periodic in-phase and out-of-phase flapping mode; or any combination thereof. In some embodiments, the two or more modular wing units alter a characteristic of the aerial vehicle. In some embodiments, the flight characteristic comprises a roll, a pitch, a yaw, or any combination thereof of the aerial vehicle.

Another aspect provided herein is a modular aerial vehicle comprising: a hull; and two or more modular wing units removably coupled to the hull, each modular wing unit comprising: an actuator; and a wing actuated by the actuator in a flapping motion to propel the hull; and a flight controller individually controlling the actuator of each of the two or more modular wing units.

In some embodiments, each of the two or more modular wing units is pivotable about the hull. In some embodiments, the two or more modular wing units releasably and operably couple to a top portion, a bottom portion, a front portion, a rear portion, a side portion, or any combination thereof of the hull. In some embodiments, the two or more modular wing units releasably and operably couple to the hull without the use of tools. In some embodiments, the two or more modular wing units releasably and operably couple to the hull in less than about 10 minutes. In some embodiments, the actuator comprises a motor, a solenoid, a spring, a piston, or any combination thereof. In some embodiments, the actuator individually actuates and controls only one single wing. In some embodiments, the actuator actuates the single wing via a linkage. In some embodiments, the actuator directly actuates the single wing. In some embodiments, the actuator actuates the single wing in the flapping motion by controlling a flapping velocity, a flapping amplitude, a flapping angle, or any combination thereof of the single wing. In some embodiments, the actuator operates in a sinusoidal waveform profile, a square waveform profile, a hybrid sinusoidal-square waveform profile, or any combination thereof. In some embodiments, the flapping motion comprises an oscillating motion, a continuous rotation, or both. In some embodiments, the flapping motion has a sinusoidal waveform profile, a square waveform profile, a hybrid sinusoidal-square waveform profile, or any combination thereof. In some embodiments, the flapping motion is at or near a resonance frequency of the single wing. In some embodiments, the two or more modular wing units flap their single wings in an out-of-phase mode and an in-phase mode. In some embodiments, the two or more modular wing units flap their single wing in the out-of-phase mode for a first duration and in the in-phase mode for a second duration. In some embodiments, a first portion of the two or more modular wing units flap their single wings in the out-of-phase mode, and wherein a second portion of the two or more modular wing units flap their single wing in the in-phase mode. In some embodiments, the modular wing unit further comprises an energy recovery unit coupled to the actuator, the single wing, or both. In some embodiments, the energy recovery unit imparts a returning force on the single wing towards a center point of the flapping motion. In some embodiments, the energy recovery unit generates lift and improves an operational efficiency of the modular wing unit. In some embodiments, the aerial vehicle further comprises a controller directing the actuator of each of the two or more modular units. In some embodiments, the flight controller individually controls the motors of the two or more modular wing units in: an in-phase wing flapping mode; an out-of-phase wing flapping mode; a sequential wing flapping mode; a periodic in-phase and out-of-phase flapping mode; or any combination thereof kit the two or more modular wing units alter a characteristic of the aerial vehicle. In some embodiments, the flight characteristic comprises a roll, a pitch, a yaw, or any combination thereof of the aerial vehicle.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a perspective view illustration of a first exemplary modular aerial vehicle, per some embodiments herein;

FIG. 2 shows a perspective view illustration of a first exemplary modular wing unit, per some embodiments herein;

FIG. 3 shows a first perspective view illustration of a second exemplary modular aerial vehicle, per some embodiments herein;

FIG. 4 shows a perspective view illustration of a second exemplary modular wing unit, per some embodiments herein;

FIG. 5 shows an image of the second exemplary modular wing unit, per some embodiments herein; and

FIG. 6 shows a non-limiting example of a computing device; in this case, a device with one or more processors, memory, storage, and a network interface.

### DETAILED DESCRIPTION

Flapping Wing Micro Aerial Vehicles (FWMAVs) can be produced at low costs, small sizes, and exhibit high maneuverability, high efficiency, stealth, and weather tolerance. While current FWMAVs employ a single drive mechanism to actuate two or more flapping wings, there is a current unmet need for an aerial vehicle comprising two or more wing units that can be driven individually. Such individual lift and propulsion control enables greater vehicle control for increased maneuverability and weather tolerance.

### Modular Aerial Vehicle Kits

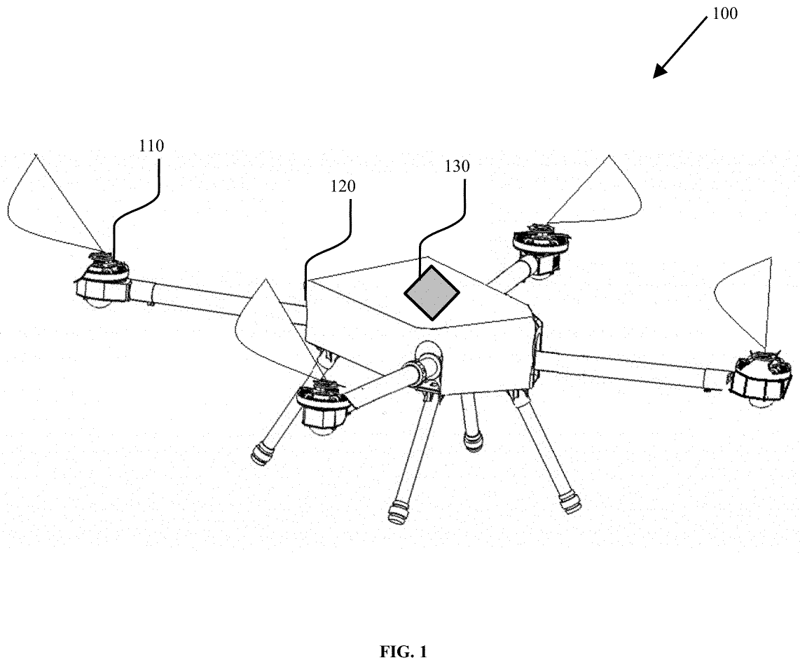

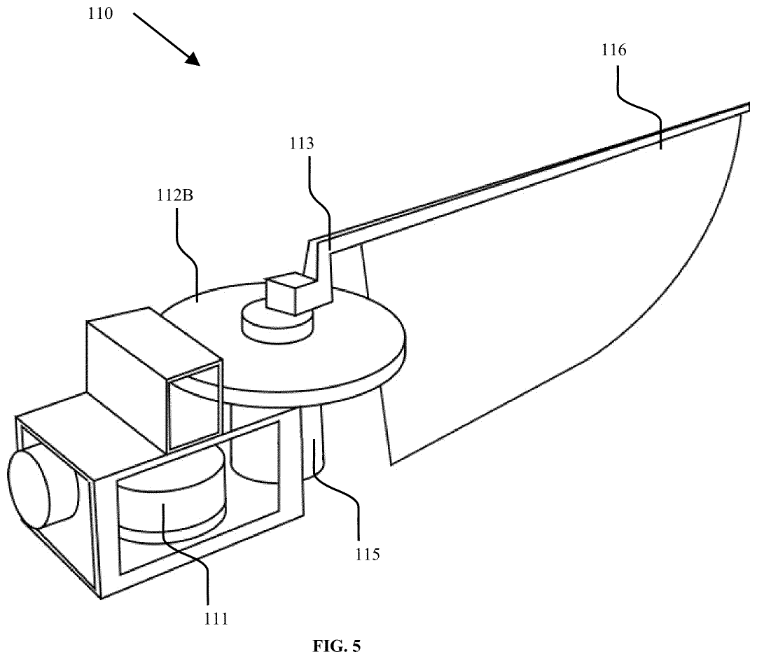

One aspect provided herein, per FIGS. 1-6 is a modular aerial vehicle kit 100 comprising a hull 120 and two or more modular wing units 110. In some embodiments, each modular wing unit 110 comprises a single wing 116 and an actuator 111. In some embodiments, the single wing 116 is configured to generate lift, thrust, or both via a flapping motion. In some embodiments, the single wing 116 is actuated by the actuator 111 in a flapping motion. In some embodiments, the actuator 111 actuates the single wing 116 in the flapping motion to propel the hull 120.

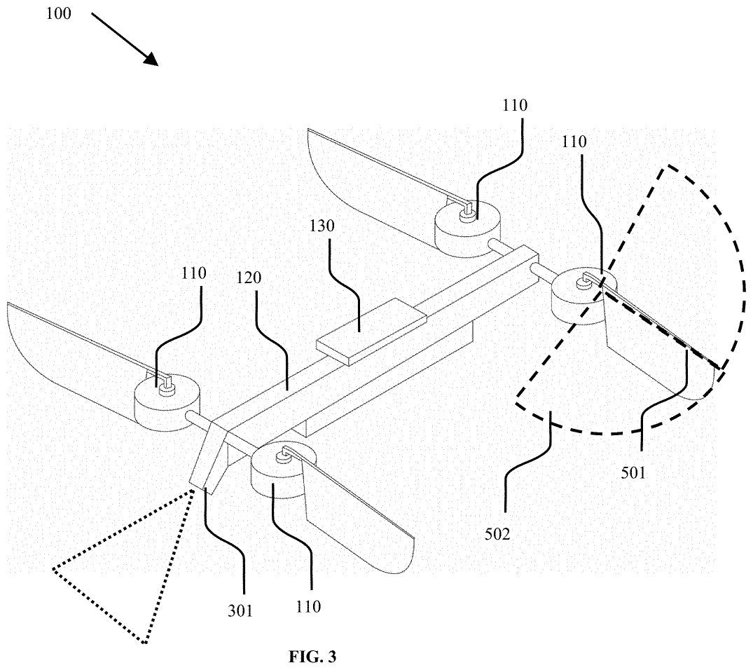

As shown in FIG. 3, the single wing 116 comprises a single component with multiple supporting spars. In some embodiments, the single wing 116 is a rigid wing or a flexible wing. In some embodiments, the single wing 116 is a rigid wing has a length of less than half the length of the aerial vehicle 100. In some embodiments, the single wing 116 is a rigid wing. In some embodiments, the single wing 116 has a length of greater than half the length of the aerial vehicle 100. In some embodiments, the single wing 116 is made of plastic, metal, wood, ceramics, fiberglass, feathers, or any combination thereof. In some embodiments, at least one of the material, the size, and the mass of the single wing 116 provided herein enables the flapping motion with a frequency of about 5 Hz to about 80 Hz.

In some embodiments, the modular aerial vehicle kit 100 further comprises a flight controller 130. In some embodiments, the hull 120 further comprises the flight controller 130. In some embodiments, the flight controller 130 directs the actuator 111 of each of the two or more modular units. In some embodiments, each of the two or more modular wing units 110 is individually controlled. In some embodiments, each of the two or more modular wing units 110 is individually controlled to alter a flight characteristic of the aerial vehicle 100. In some embodiments, the flight characteristic comprises a roll, a pitch, a yaw, or any combination thereof of the aerial vehicle 100. In some embodiments, the flight controller 130 individually controls the actuator 111 of each of the two or more modular wing units 110. In some embodiments, the modular aerial vehicle kit 100 does not comprise the flight controller 130. In some embodiments, the flight controller 130 receives a control signal to control the actuator 111 of each of the two or more modular units from a base controller, another aerial vehicle 100, or any combination thereof. In some embodiments, the base controller comprises a human operated base controller or an autonomous base controller. In some embodiments, one aerial vehicle 100, receives the control signal from the base controller, and transmits the control signal, or an alternative signal based on the control signal, to another aerial vehicle 100.

As shown the actuator 111 comprises a motor. In some embodiments, the motor comprises a brushed motor or a brushless motor. In some embodiments, the actuator 111 directly actuates the single wing 116. Alternatively, in some embodiments, the actuator 111 comprises a solenoid, a spring, a piston, or any combination thereof. As shown, the oscillation or rotation of the actuator 111 flaps the single wing 116. In some embodiments, at least one of the type, the voltage, the amperage, the power, and the mass of the actuators 111 provided herein enable the flapping motion with a frequency of about 5 Hz to about 80 Hz.

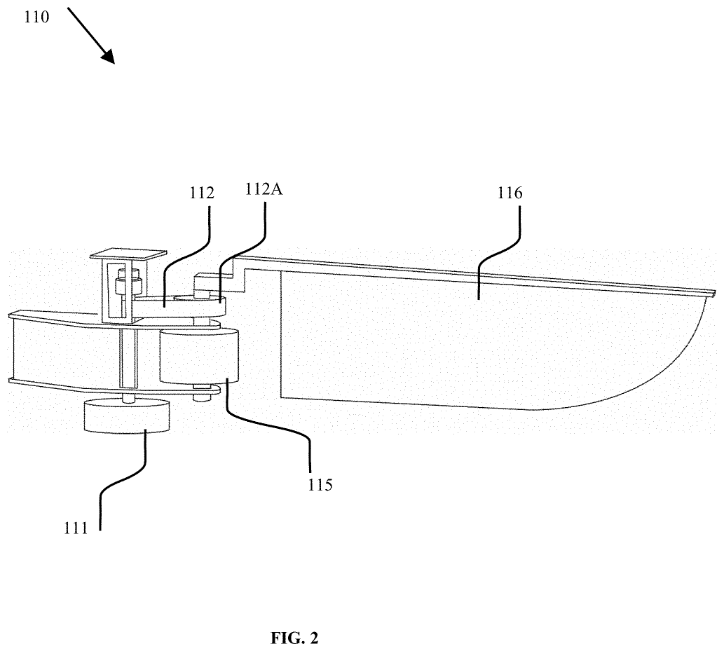

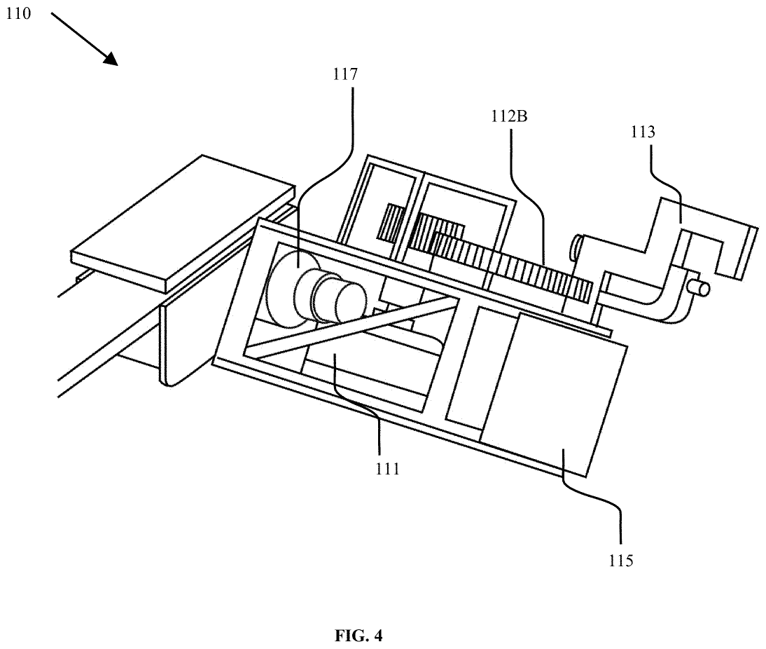

In some embodiments, the actuator 111 actuates the single wing 116 via a linkage 112. In some embodiments, the single wing 116 is rigidly attached to the linkage 112. In some embodiments, the single wing 116 is removable attached to the linkage 112. In some embodiments, the single wing 116 can retract with respect to the linkage 112 for storage or landing. In some embodiments, the linkage comprises a wrist attachment 113 rotatably coupled to an actuator 111. In one embodiment, per FIG. 2, the linkage 112 further comprises a pulley wheel 112A transferring rotational force between the actuator 111 and the wrist attachment 113. In some embodiments, the wrist attachment 113 rotatably couples to the pulley wheel 112A via a wrist pin. In another embodiment, per FIG. 4, the linkage 112 further comprises a gear set 112B transferring rotational force between the actuator 111 and the wrist attachment 113. In some embodiments, the wrist attachment rotatably couples to the gear set 112B via a wrist pin. As shown in FIG. 4, the gear set 112B comprises a first gear coupled to the actuator 111 and a second gear that is coupled to the wrist attachment 113, wherein rotation of the first gear rotates the second gear. In some embodiments, the gear ratios provided herein enable the flapping motion with a frequency of about 5 Hz to about 80 Hz.

In some embodiments, a gear ratio of the first gear to the second gear is about 2:1 to about 14:1. In some embodiments, a gear ratio of the first gear to the second gear is about 2:1 to about 3:1, about 2:1 to about 4:1, about 2:1 to about 5:1, about 2:1 to about 6:1, about 2:1 to about 7:1, about 2:1 to about 8:1, about 2:1 to about 9:1, about 2:1 to about 10:1, about 2:1 to about 12:1, about 2:1 to about 14:1, about 3:1 to about 4:1, about 3:1 to about 5:1, about 3:1 to about 6:1, about 3:1 to about 7:1, about 3:1 to about 8:1, about 3:1 to about 9:1, about 3:1 to about 10:1, about 3:1 to about 12:1, about 3:1 to about 14:1, about 4:1 to about 5:1, about 4:1 to about 6:1, about 4:1 to about 7:1, about 4:1 to about 8:1, about 4:1 to about 9:1, about 4:1 to about 10:1, about 4:1 to about 12:1, about 4:1 to about 14:1, about 5:1 to about 6:1, about 5:1 to about 7:1, about 5:1 to about 8:1, about 5:1 to about 9:1, about 5:1 to about 10:1, about 5:1 to about 12:1, about 5:1 to about 14:1, about 6:1 to about 7:1, about 6:1 to about 8:1, about 6:1 to about 9:1, about 6:1 to about 10:1, about 6:1 to about 12:1, about 6:1 to about 14:1, about 7:1 to about 8:1, about 7:1 to about 9:1, about 7:1 to about 10:1, about 7:1 to about 12:1, about 7:1 to about 14:1, about 8:1 to about 9:1, about 8:1 to about 10:1, about 8:1 to about 12:1, about 8:1 to about 14:1, about 9:1 to about 10:1, about 9:1 to about 12:1, about 9:1 to about 14:1, about 10:1 to about 12:1, about 10:1 to about 14:1, or about 12:1 to about 14:1. In some embodiments, a gear ratio of the first gear to the second gear is about 2:1, about 3:1, about 4:1, about 5:1, about 6:1, about 7:1, about 8:1, about 9:1, about 10:1, about 12:1, or about 14:1. In some embodiments, a gear ratio of the first gear to the second gear is at least about 2:1, about 3:1, about 4:1, about 5:1, about 6:1, about 7:1, about 8:1, about 9:1, about 10:1, or about 12:1. In some embodiments, a gear ratio of the first gear to the second gear is at most about 3:1, about 4:1, about 5:1, about 6:1, about 7:1, about 8:1, about 9:1, about 10:1, about 12:1, or about 14:1.

Alternatively, in some embodiments, the linkage 112 further comprises a cable, a crank, a string, a sprocket, a band, a coupling, a gearbox, or any combination thereof.

In some embodiments, the wrist attachment has a wing pin that rotatably couples to the single wing 116 to the wrist attachment 113. In some embodiments, the single wing 116 rotates freely about the wrist attachment 113. In some embodiments, the flapping amplitude of the single wing 116 can be controlled to vary the angle of attack of the single wing 116. In some embodiments, varying the angle of attack of the single wing 116 alters the magnitude of the lift vector and resulting vehicle velocity. In one embodiment, the angle of attack is adjusted manually by an angle of attack control. In some embodiments, the angle of attack control comprises a first set screw, a second set screw (not shown), a first contact surface of the wrist attachment 113, and a second contact surface of the wrist attachment 113. In some embodiments, the first set screw and the first contact surface of the wrist attachment 113, is positioned on an opposite side of the wrist attachment 113 than the second set screw and the second contact surface of the wrist attachment 113. Thus, in some embodiments, as the wrist attachment 113 rotates about the wrist pin a first direction, whereas a top face of the first set screw contacts the first contact surface of the wrist attachment 113, preventing further rotation of the wrist attachment 113 in the first direction. In some embodiments, as the wrist attachment 113 rotates about the wrist pin in a second direction opposite the first direction, a top face of the second set screw contacts the second contact surface of the wrist attachment 113, preventing further rotation of the wrist attachment in the second direction. Alternatively, in some embodiments, the angle of attack of the single wing 116 is adjusted through a cam, a bearing, a slide, a spring, a threaded rod, or any combination thereof. Alternatively, in some embodiments, the angle of attack of the single wing 116 is automatically adjusted by an angle of attack actuator. In some embodiments, the angle of attack actuator is controlled by the motor controller 130.

In some embodiments, the actuator 111 individually actuates and controls only one single wing 116. In some embodiments, the actuator 111 actuates the single wing 116 in the flapping motion by controlling a flapping velocity, a flapping amplitude, a flapping angle, or any combination thereof of the single wing 116. In some embodiments, the actuator 111 operates in a sinusoidal waveform profile, a square waveform profile, a hybrid sinusoidal-square waveform profile, or any combination thereof. In some embodiments, the flapping motion comprises an oscillating motion, a continuous rotation, or both. In some embodiments, the flapping motion has a sinusoidal waveform profile, a square waveform profile, a hybrid sinusoidal-square waveform profile, or any combination thereof. In some embodiments, the flapping motion has a frequency near the resonance frequency of the single wing 116. The waveform for driving the actuator 111 can be optimized for actuator 111 efficiency, by for example, through the use of hybrid waveform profiles. A hybrid waveform profile may include combinations of two or more different types of waveform profiles. The actuator 111 efficiency can be optimized by adjusting a ratio between the two or more different types of waveform profiles. In some embodiments, the two or more different types of waveform profiles may include a sine wave and a square wave.

In some embodiments, a ratio between the square wave to the sine wave of the hybrid sinusoidal-square waveform profile is about 1:1 to about 4:1. In some embodiments, a ratio between the square wave to the sine wave of the hybrid sinusoidal-square waveform profile is about 1:1 to about 1.5:1, about 1:1 to about 2:1, about 1:1 to about 2.5:1, about 1:1 to about 3:1, about 1:1 to about 3.5:1, about 1:1 to about 4:1, about 1.5:1 to about 2:1, about 1.5:1 to about 2.5:1, about 1.5:1 to about 3:1, about 1.5:1 to about 3.5:1, about 1.5:1 to about 4:1, about 2:1 to about 2.5:1, about 2:1 to about 3:1, about 2:1 to about 3.5:1, about 2:1 to about 4:1, about 2.5:1 to about 3:1, about 2.5:1 to about 3.5:1, about 2.5:1 to about 4:1, about 3:1 to about 3.5:1, about 3:1 to about 4:1, or about 3.5:1 to about 4:1. In some embodiments, a ratio between the square wave to the sine wave of the hybrid sinusoidal-square waveform profile is about 1:1, about 1.5:1, about 2:1, about 2.5:1, about 3:1, about 3.5:1, or about 4:1. In some embodiments, a ratio between the square wave to the sine wave of the hybrid sinusoidal-square waveform profile is at least about 1:1, about 1.5:1, about 2:1, about 2.5:1, about 3:1, or about 3.5:1. In some embodiments, a ratio between the square wave to the sine wave of the hybrid sinusoidal-square waveform profile is at most about 1.5:1, about 2:1, about 2.5:1, about 3:1, about 3.5:1, or about 4:1. In some preferred embodiments, a ratio of the sine wave to the square wave is about 0.3. In one example, a ratio of the sine wave to the square wave is 0.32.

In some embodiments, the two or more modular wing units 110 releasably and operably couple to the hull 120. In some embodiments, the two or more modular wing units 110 releasably and operably couple to the hull 120 to form an aerial vehicle 100. In some embodiments, the two or more modular wing units 110 releasably and operably couple to a top portion, a bottom portion, a front portion, a rear portion, a side portion, or any combination thereof of the hull 120. In some embodiments, the two or more modular wing units 110 comprises 2, 3, 4, 5, 6, 7, 8, 9, 10, 15, 20, 25, or more modular wing units 110. In some embodiments, the two or more modular wing units 110 releasably and operably couple to the hull 120 without the use of tools. In some embodiments, the two or more modular wing units 110 releasably and operably couple to the hull 120 in less than about 10 minutes.

In some embodiments, each of the two or more modular wing units 110 is pivotable about the hull 120. As shown in FIG. 4, the modular wing unit 110 releasably and operably couples to the hull 120 via a bearing 117. As shown, the bearing 117 releasably and operably couples the modular wing unit 110 to the hull 120 such that the modular wing unit 110 can freely rotate about the hull 120. Alternatively, in some embodiments, each of the two or more modular wing units 110 are pivotable about the hull 120 via a slide, a ball and socket joint, a clamp, or any combination thereof. In some embodiments, each of the two or more modular wing units 110 are pivotable about one or more axes with respect to the hull 120. In some embodiments, each of the two or more modular wing units 110 are pivotable about one or more degrees of freedom with respect to the hull 120. In some embodiments, each of the two or more modular wing units 110 is mechanically actuated about one or more axes with respect to the hull 120. In some embodiments, each of the two or more modular wing units 110 is mechanically rotated about one or more axes with respect to the hull 120 to modify a stroke plane of the single wing 116. In some embodiments, rotating the modular wing units 110 to modify the stroke plane of the single wing 116 alters a flight characteristic of the aerial vehicle 100.

In some embodiments, the modular wing unit 110 further comprises an energy recovery unit 115 coupled to the actuator 111, the single wing 116, or both. As shown in FIG. 2, the energy recovery unit 115 comprises a spring, As shown in FIG. 2, in some embodiments, the energy recovery unit 115 comprises a coil spring. In some embodiments, the energy recovery unit 115 comprises a helical spring. Alternatively, in some embodiments, the energy recovery unit 115 comprises a piston, a flexure, a dashpot, or any combination thereof. Alternatively, in some embodiments, the spring comprises a linear spring, a leaf spring, a spiral spring, a machined spring, or any combination thereof. In some embodiments, the energy recovery unit 115 generates lift and improves an operational efficiency of the modular wing unit. In some embodiments, at least one of the type, the weight, and the spring rate of the energy recovery unit 115 provided herein enables the flapping motion with a frequency of about 5 Hz to about 80 Hz.

In some embodiments, the energy recovery unit 115 has a spring rate of about 0.25 Nmm/deg to about 14 Nmm/deg. In some embodiments, the energy recovery unit 115 has a spring rate of about 0.25 Nmm/deg to about 0.75 Nmm/deg, about 0.25 Nmm/deg to about 0.5 Nmm/deg, about 0.25 Nmm/deg to about 1 Nmm/deg, about 0.25 Nmm/deg to about 1.25 Nmm/deg, about 0.25 Nmm/deg to about 1.5 Nmm/deg, about 0.25 Nmm/deg to about 1.75 Nmm/deg, about 0.25 Nmm/deg to about 2 Nmm/deg, about 0.25 Nmm/deg to about 2.5 Nmm/deg, about 0.25 Nmm/deg to about 3 Nmm/deg, about 0.25 Nmm/deg to about 14 Nmm/deg, about 0.75 Nmm/deg to about 0.5 Nmm/deg, about 0.75 Nmm/deg to about 1 Nmm/deg, about 0.75 Nmm/deg to about 1.25 Nmm/deg, about 0.75 Nmm/deg to about 1.5 Nmm/deg, about 0.75 Nmm/deg to about 1.75 Nmm/deg, about 0.75 Nmm/deg to about 2 Nmm/deg, about 0.75 Nmm/deg to about 2.5 Nmm/deg, about 0.75 Nmm/deg to about 3 Nmm/deg, about 0.75 Nmm/deg to about 14 Nmm/deg, about 0.5 Nmm/deg to about 1 Nmm/deg, about 0.5 Nmm/deg to about 1.25 Nmm/deg, about 0.5 Nmm/deg to about 1.5 Nmm/deg, about 0.5 Nmm/deg to about 1.75 Nmm/deg, about 0.5 Nmm/deg to about 2 Nmm/deg, about 0.5 Nmm/deg to about 2.5 Nmm/deg, about 0.5 Nmm/deg to about 3 Nmm/deg, about 0.5 Nmm/deg to about 14 Nmm/deg, about 1 Nmm/deg to about 1.25 Nmm/deg, about 1 Nmm/deg to about 1.5 Nmm/deg, about 1 Nmm/deg to about 1.75 Nmm/deg, about 1 Nmm/deg to about 2 Nmm/deg, about 1 Nmm/deg to about 2.5 Nmm/deg, about 1 Nmm/deg to about 3 Nmm/deg, about 1 Nmm/deg to about 14 Nmm/deg, about 1.25 Nmm/deg to about 1.5 Nmm/deg, about 1.25 Nmm/deg to about 1.75 Nmm/deg, about 1.25 Nmm/deg to about 2 Nmm/deg, about 1.25 Nmm/deg to about 2.5 Nmm/deg, about 1.25 Nmm/deg to about 3 Nmm/deg, about 1.25 Nmm/deg to about 14 Nmm/deg, about 1.5 Nmm/deg to about 1.75 Nmm/deg, about 1.5 Nmm/deg to about 2 Nmm/deg, about 1.5 Nmm/deg to about 2.5 Nmm/deg, about 1.5 Nmm/deg to about 3 Nmm/deg, about 1.5 Nmm/deg to about 14 Nmm/deg, about 1.75 Nmm/deg to about 2 Nmm/deg, about 1.75 Nmm/deg to about 2.5 Nmm/deg, about 1.75 Nmm/deg to about 3 Nmm/deg, about 1.75 Nmm/deg to about 14 Nmm/deg, about 2 Nmm/deg to about 2.5 Nmm/deg, about 2 Nmm/deg to about 3 Nmm/deg, about 2 Nmm/deg to about 14 Nmm/deg, about 2.5 Nmm/deg to about 3 Nmm/deg, about 2.5 Nmm/deg to about 14 Nmm/deg, or about 3 Nmm/deg to about 14 Nmm/deg. In some embodiments, the energy recovery unit 115 has a spring rate of about 0.25 Nmm/deg, about 0.75 Nmm/deg, about 0.5 Nmm/deg, about 1 Nmm/deg, about 1.25 Nmm/deg, about 1.5 Nmm/deg, about 1.75 Nmm/deg, about 2 Nmm/deg, about 2.5 Nmm/deg, about 3 Nmm/deg, or about 14 Nmm/deg. In some embodiments, the energy recovery unit 115 has a spring rate of at least about 0.25 Nmm/deg, about 0.75 Nmm/deg, about 0.5 Nmm/deg, about 1 Nmm/deg, about 1.25 Nmm/deg, about 1.5 Nmm/deg, about 1.75 Nmm/deg, about 2 Nmm/deg, about 2.5 Nmm/deg, or about 3 Nmm/deg. In some embodiments, the energy recovery unit 115 has a spring rate of at most about 0.75 Nmm/deg, about 0.5 Nmm/deg, about 1 Nmm/deg, about 1.25 Nmm/deg, about 1.5 Nmm/deg, about 1.75 Nmm/deg, about 2 Nmm/deg, about 2.5 Nmm/deg, about 3 Nmm/deg, or about 14 Nmm/deg.

In some embodiments, per FIG. 2, the energy recovery unit 115 imparts a returning force on the single wing 116 towards a center point 501 of the flapping trajectory 502. In some embodiments, the modular wing units 110 are arranged on the hull 120 such that the flapping trajectories 502 of neighboring single wings 116 cannot collide. In some embodiments, the actuator 111 actuates the modular wing unit 110 in the flapping trajectories 502 so that neighboring single wings 116 do not collide. In some embodiments, the motor controller 130 controls the actuators 111 of each of the modular wing units 110 to impart a specific flapping trajectory 502 such that neighboring single wings 116 do not collide. In some embodiments, the flapping trajectories 502 of two or more neighboring single wings 116 are generally parallel. In some embodiments, the flapping trajectories 502 of two or more neighboring single wings 116 are generally coplanar. In some embodiments, the flapping trajectories 502 of two or more neighboring single wings 116 are non-coplanar. In some embodiments, the flapping trajectories 502 of two or more neighboring single wings 116 intersect or overlap with one another.

In some embodiments, the modular aerial vehicle kit 100 further comprises an encoder measuring an angle of the single wing 116 with respect to the hull 120. In some embodiments, the modular aerial vehicle kit 100 further comprises an encoder measuring an angle of each single wing 116 with respect to the hull 120. In some embodiments, the encoder is integrated into each actuator 111. In some embodiments, the encoder comprises a magnetic encoder, an optical encoder, or both. In some embodiments, the motor controller 130 receives the angle of the single wing 116 with respect to the hull 120 from one or more of the encoders. In some embodiments, the controller 130 determines a wind gust direction, a wind gust rotation, or both from the angle one or more of the single wings 116 with respect to the hull 120. In some embodiments, the controller 130 determines the wind gust direction, the wind gust rotation, or both by comparing the signal sent to the actuator 111 with the angle of the single wing 116 with respect to the hull 120. In some embodiments, the controller 130 determines the wind gust direction, the wind gust rotation, or both by comparing the signal sent to each actuator 111 with the angle of each single wing 116 with respect to the hull 120. In some embodiments, the use of the encoder herein enables increased maneuverability, weather tolerance, gust tolerance or any combination thereof of the modular aerial vehicle 100.

In the embodiment show in FIG. 2, the actuator 111 drives the rotation of a shaft which rotates the wing through a linkage 112 mechanism, wherein the wing is connected to the energy recovery unit 115. In such an embodiment, the actuator 111 is sequentially actuated in a clockwise and counterclockwise waveform. Further, in some embodiments, when the actuator 111 actuates the wing in a first direction a potential energy of the energy recovery unit 115 increases. Once the actuator 111 begins to actuate the wing opposite the first direction, energy stored within the energy recovery unit 115 is returned to the wing, allowing for greater accelerations in reaction to the momentum change.

In some embodiments, the two or more modular wing units 110 flap their single wings 116 in an out-of-phase mode and an in-phase mode. In one example, two wings flapping in an out-of-phase mode are asynchronous. In one example, two wings flapping in an out-of-phase mode are offset in their flapping motion by half a flapping period. In one example, two wings flapping in an out-of-phase mode are synchronous. In one example, two wings flapping in an out-of-phase mode are not offset in their flapping motion. In some embodiments, the two or more modular wing units 110 flap their single wing 116 in the out-of-phase mode for a first duration and in the in-phase mode for a second duration. In some embodiments, a first portion of the two or more modular wing units 110 flap their single wings 116 in the out-of-phase mode, and wherein a second portion of the two or more modular wing units 110 flap their single wing 116 in the in-phase mode. In some embodiments, the flight controller 130 individually controls the actuators 111 of the two or more modular wing units 110 in an in-phase wing flapping mode, an out-of-phase wing flapping mode, a sequential wing flapping mode, a periodic in-phase and out-of-phase flapping mode, or any combination thereof.

In some embodiments, at least one of the type, the voltage, the amperage, the power, and the mass of the motors provided herein enable the flapping motion with a frequency of about 5 Hz to about 80 Hz. In some embodiments, the motor has a voltage of about 2 V to about 16 V. In some embodiments, the motor has a voltage of about 2 V to about 4 V, about 2 V to about 6 V, about 2 V to about 8 V, about 2 V to about 10 V, about 2 V to about 12 V, about 2 V to about 14 V, about 2 V to about 16 V, about 4 V to about 6 V, about 4 V to about 8 V, about 4 V to about 10 V, about 4 V to about 12 V, about 4 V to about 14 V, about 4 V to about 16 V, about 6 V to about 8 V, about 6 V to about 10 V, about 6 V to about 12 V, about 6 V to about 14 V, about 6 V to about 16 V, about 8 V to about 10 V, about 8 V to about 12 V, about 8 V to about 14 V, about 8 V to about 16 V, about 10 V to about 12 V, about 10 V to about 14 V, about 10 V to about 16 V, about 12 V to about 14 V, about 12 V to about 16 V, or about 14 V to about 16 V. In some embodiments, the motor has a voltage of about 2 V, about 4 V, about 6 V, about 8 V, about 10 V, about 12 V, about 14 V, or about 16 V. In some embodiments, the motor has a voltage of at least about 2 V, about 4 V, about 6 V, about 8 V, about 10 V, about 12 V, or about 14 V. In some embodiments, the motor has a voltage of at most about 4 V, about 6 V, about 8 V, about 10 V, about 12 V, about 14 V, or about 16 V.

In some embodiments, the motor has a current of about 0.1 A to about 4 A. In some embodiments, the motor has a current of about 0.1 A to about 0.5 A, about 0.1 A to about 1 A, about 0.1 A to about 1.5 A, about 0.1 A to about 2 A, about 0.1 A to about 2.5 A, about 0.1 A to about 3 A, about 0.1 A to about 3.5 A, about 0.1 A to about 4 A, about 0.5 A to about 1 A, about 0.5 A to about 1.5 A, about 0.5 A to about 2 A, about 0.5 A to about 2.5 A, about 0.5 A to about 3 A, about 0.5 A to about 3.5 A, about 0.5 A to about 4 A, about 1 A to about 1.5 A, about 1 A to about 2 A, about 1 A to about 2.5 A, about 1 A to about 3 A, about 1 A to about 3.5 A, about 1 A to about 4 A, about 1.5 A to about 2 A, about 1.5 A to about 2.5 A, about 1.5 A to about 3 A, about 1.5 A to about 3.5 A, about 1.5 A to about 4 A, about 2 A to about 2.5 A, about 2 A to about 3 A, about 2 A to about 3.5 A, about 2 A to about 4 A, about 2.5 A to about 3 A, about 2.5 A to about 3.5 A, about 2.5 A to about 4 A, about 3 A to about 3.5 A, about 3 A to about 4 A, or about 3.5 A to about 4 A. In some embodiments, the motor has a current of about 0.1 A, about 0.5 A, about 1 A, about 1.5 A, about 2 A, about 2.5 A, about 3 A, about 3.5 Å, or about 4 A. In some embodiments, the motor has a current of at least about 0.1 A, about 0.5 A, about 1 A, about 1.5 A, about 2 A, about 2.5 A, about 3 A, or about 3.5 A. In some embodiments, the motor has a current of at most about 0.5 A, about 1 A, about 1.5 A, about 2 A, about 2.5 A, about 3 A, about 3.5 Å, or about 4 A.

In some embodiments, the motor has a power of about 0.5 W to about 20 W. In some embodiments, the motor has a power of about 0.5 W to about 1 W, about 0.5 W to about 2 W, about 0.5 W to about 4 W, about 0.5 W to about 6 W, about 0.5 W to about 8 W, about 0.5 W to about 10 W, about 0.5 W to about 12 W, about 0.5 W to about 14 W, about 0.5 W to about 16 W, about 0.5 W to about 18 W, about 0.5 W to about 20 W, about 1 W to about 2 W, about 1 W to about 4 W, about 1 W to about 6 W, about 1 W to about 8 W, about 1 W to about 10 W, about 1 W to about 12 W, about 1 W to about 14 W, about 1 W to about 16 W, about 1 W to about 18 W, about 1 W to about 20 W, about 2 W to about 4 W, about 2 W to about 6 W, about 2 W to about 8 W, about 2 W to about 10 W, about 2 W to about 12 W, about 2 W to about 14 W, about 2 W to about 16 W, about 2 W to about 18 W, about 2 W to about 20 W, about 4 W to about 6 W, about 4 W to about 8 W, about 4 W to about 10 W, about 4 W to about 12 W, about 4 W to about 14 W, about 4 W to about 16 W, about 4 W to about 18 W, about 4 W to about 20 W, about 6 W to about 8 W, about 6 W to about 10 W, about 6 W to about 12 W, about 6 W to about 14 W, about 6 W to about 16 W, about 6 W to about 18 W, about 6 W to about 20 W, about 8 W to about 10 W, about 8 W to about 12 W, about 8 W to about 14 W, about 8 W to about 16 W, about 8 W to about 18 W, about 8 W to about 20 W, about 10 W to about 12 W, about 10 W to about 14 W, about 10 W to about 16 W, about 10 W to about 18 W, about 10 W to about 20 W, about 12 W to about 14 W, about 12 W to about 16 W, about 12 W to about 18 W, about 12 W to about 20 W, about 14 W to about 16 W, about 14 W to about 18 W, about 14 W to about 20 W, about 16 W to about 18 W, about 16 W to about 20 W, or about 18 W to about 20 W. In some embodiments, the motor has a power of about 0.5 W, about 1 W, about 2 W, about 4 W, about 6 W, about 8 W, about 10 W, about 12 W, about 14 W, about 16 W, about 18 W, or about 20 W. In some embodiments, the motor has a power of at least about 0.5 W, about 1 W, about 2 W, about 4 W, about 6 W, about 8 W, about 10 W, about 12 W, about 14 W, about 16 W, or about 18 W. In some embodiments, the motor has a power of at most about 1 W, about 2 W, about 4 W, about 6 W, about 8 W, about 10 W, about 12 W, about 14 W, about 16 W, about 18 W, or about 20 W.

In some embodiments, the flapping motion has a frequency of about 5 Hz to about 80 Hz. In some embodiments, the flapping motion has a frequency of about 5 Hz to about 10 Hz, about 5 Hz to about 15 Hz, about 5 Hz to about 20 Hz, about 5 Hz to about 25 Hz, about 5 Hz to about 30 Hz, about 5 Hz to about 40 Hz, about 5 Hz to about 50 Hz, about 5 Hz to about 60 Hz, about 5 Hz to about 70 Hz, about 5 Hz to about 80 Hz, about 10 Hz to about 15 Hz, about 10 Hz to about 20 Hz, about 10 Hz to about 25 Hz, about 10 Hz to about 30 Hz, about 10 Hz to about 40 Hz, about 10 Hz to about 50 Hz, about 10 Hz to about 60 Hz, about 10 Hz to about 70 Hz, about 10 Hz to about 80 Hz, about 15 Hz to about 20 Hz, about 15 Hz to about 25 Hz, about 15 Hz to about 30 Hz, about 15 Hz to about 40 Hz, about 15 Hz to about 50 Hz, about 15 Hz to about 60 Hz, about 15 Hz to about 70 Hz, about 15 Hz to about 80 Hz, about 20 Hz to about 25 Hz, about 20 Hz to about 30 Hz, about 20 Hz to about 40 Hz, about 20 Hz to about 50 Hz, about 20 Hz to about 60 Hz, about 20 Hz to about 70 Hz, about 20 Hz to about 80 Hz, about 25 Hz to about 30 Hz, about 25 Hz to about 40 Hz, about 25 Hz to about 50 Hz, about 25 Hz to about 60 Hz, about 25 Hz to about 70 Hz, about 25 Hz to about 80 Hz, about 30 Hz to about 40 Hz, about 30 Hz to about 50 Hz, about 30 Hz to about 60 Hz, about 30 Hz to about 70 Hz, about 30 Hz to about 80 Hz, about 40 Hz to about 50 Hz, about 40 Hz to about 60 Hz, about 40 Hz to about 70 Hz, about 40 Hz to about 80 Hz, about 50 Hz to about 60 Hz, about 50 Hz to about 70 Hz, about 50 Hz to about 80 Hz, about 60 Hz to about 70 Hz, about 60 Hz to about 80 Hz, or about 70 Hz to about 80 Hz. In some embodiments, the flapping motion has a frequency of about 5 Hz, about 10 Hz, about 15 Hz, about 20 Hz, about 25 Hz, about 30 Hz, about 40 Hz, about 50 Hz, about 60 Hz, about 70 Hz, or about 80 Hz. In some embodiments, the flapping motion has a frequency of at least about 5 Hz, about 10 Hz, about 15 Hz, about 20 Hz, about 25 Hz, about 30 Hz, about 40 Hz, about 50 Hz, about 60 Hz, or about 70 Hz. In some embodiments, the flapping motion has a frequency of at most about 10 Hz, about 15 Hz, about 20 Hz, about 25 Hz, about 30 Hz, about 40 Hz, about 50 Hz, about 60 Hz, about 70 Hz, or about 80 Hz.

In some embodiments, the modular aerial vehicle kit 100 further comprises a battery providing energy to the actuator 111, the flight controller 130, or both. In some embodiments, the battery is coupled to the hull 120. In some embodiments, the battery is removably coupled to the hull 120. In some embodiments, per FIG. 3, the modular aerial vehicle kit 100 further comprises a sensor 301. In some embodiments, the sensor 301 is coupled to the hull 120. In some embodiments, the sensor 301 is removably coupled to the hull 120. In some embodiments, the sensor 301 comprises a camera, a range finder, a LIDAR, a RADAR, a chemical sensor, a pitot tube, a gyroscope, a microphone, an accelerometer, a humidity sensor, a rain sensor, a pressure sensor, a Time-of-Flight sensors, GPS sensor, or any combination thereof.

In some embodiments, the battery has a voltage of about 2 V to about 16 V. In some embodiments, the battery has a voltage of about 2 V to about 4 V, about 2 V to about 6 V, about 2 V to about 8 V, about 2 V to about 10 V, about 2 V to about 12 V, about 2 V to about 14 V, about 2 V to about 16 V, about 4 V to about 6 V, about 4 V to about 8 V, about 4 V to about 10 V, about 4 V to about 12 V, about 4 V to about 14 V, about 4 V to about 16 V, about 6 V to about 8 V, about 6 V to about 10 V, about 6 V to about 12 V, about 6 V to about 14 V, about 6 V to about 16 V, about 8 V to about 10 V, about 8 V to about 12 V, about 8 V to about 14 V, about 8 V to about 16 V, about 10 V to about 12 V, about 10 V to about 14 V, about 10 V to about 16 V, about 12 V to about 14 V, about 12 V to about 16 V, or about 14 V to about 16 V. In some embodiments, the battery has a voltage of about 2 V, about 4 V, about 6 V, about 8 V, about 10 V, about 12 V, about 14 V, or about 16 V. In some embodiments, the battery has a voltage of at least about 2 V, about 4 V, about 6 V, about 8 V, about 10 V, about 12 V, or about 14 V. In some embodiments, the battery has a voltage of at most about 4 V, about 6 V, about 8 V, about 10 V, about 12 V, about 14 V, or about 16 V.

In some embodiments, the battery has a current of about 0.1 A to about 4 A. In some embodiments, the battery has a current of about 0.1 A to about 0.5 A, about 0.1 A to about 1 A, about 0.1 A to about 1.5 A, about 0.1 A to about 2 A, about 0.1 A to about 2.5 A, about 0.1 A to about 3 A, about 0.1 A to about 3.5 A, about 0.1 A to about 4 A, about 0.5 A to about 1 A, about 0.5 A to about 1.5 A, about 0.5 A to about 2 A, about 0.5 A to about 2.5 A, about 0.5 A to about 3 A, about 0.5 A to about 3.5 A, about 0.5 A to about 4 A, about 1 A to about 1.5 A, about 1 A to about 2 A, about 1 A to about 2.5 A, about 1 A to about 3 A, about 1 A to about 3.5 A, about 1 A to about 4 A, about 1.5 A to about 2 A, about 1.5 A to about 2.5 A, about 1.5 A to about 3 A, about 1.5 A to about 3.5 A, about 1.5 A to about 4 A, about 2 A to about 2.5 A, about 2 A to about 3 A, about 2 A to about 3.5 A, about 2 A to about 4 A, about 2.5 A to about 3 A, about 2.5 A to about 3.5 A, about 2.5 A to about 4 A, about 3 A to about 3.5 A, about 3 A to about 4 A, or about 3.5 A to about 4 A. In some embodiments, the battery has a current of about 0.1 A, about 0.5 A, about 1 A, about 1.5 A, about 2 A, about 2.5 A, about 3 A, about 3.5 Å, or about 4 A. In some embodiments, the battery has a current of at least about 0.1 A, about 0.5 A, about 1 A, about 1.5 A, about 2 A, about 2.5 A, about 3 A, or about 3.5 A. In some embodiments, the battery has a current of at most about 0.5 A, about 1 A, about 1.5 A, about 2 A, about 2.5 A, about 3 A, about 3.5 Å, or about 4 A.

In some embodiments, the battery has a power of about 0.5 W to about 20 W. In some embodiments, the battery has a power of about 0.5 W to about 1 W, about 0.5 W to about 2 W, about 0.5 W to about 4 W, about 0.5 W to about 6 W, about 0.5 W to about 8 W, about 0.5 W to about 10 W, about 0.5 W to about 12 W, about 0.5 W to about 14 W, about 0.5 W to about 16 W, about 0.5 W to about 18 W, about 0.5 W to about 20 W, about 1 W to about 2 W, about 1 W to about 4 W, about 1 W to about 6 W, about 1 W to about 8 W, about 1 W to about 10 W, about 1 W to about 12 W, about 1 W to about 14 W, about 1 W to about 16 W, about 1 W to about 18 W, about 1 W to about 20 W, about 2 W to about 4 W, about 2 W to about 6 W, about 2 W to about 8 W, about 2 W to about 10 W, about 2 W to about 12 W, about 2 W to about 14 W, about 2 W to about 16 W, about 2 W to about 18 W, about 2 W to about 20 W, about 4 W to about 6 W, about 4 W to about 8 W, about 4 W to about 10 W, about 4 W to about 12 W, about 4 W to about 14 W, about 4 W to about 16 W, about 4 W to about 18 W, about 4 W to about 20 W, about 6 W to about 8 W, about 6 W to about 10 W, about 6 W to about 12 W, about 6 W to about 14 W, about 6 W to about 16 W, about 6 W to about 18 W, about 6 W to about 20 W, about 8 W to about 10 W, about 8 W to about 12 W, about 8 W to about 14 W, about 8 W to about 16 W, about 8 W to about 18 W, about 8 W to about 20 W, about 10 W to about 12 W, about 10 W to about 14 W, about 10 W to about 16 W, about 10 W to about 18 W, about 10 W to about 20 W, about 12 W to about 14 W, about 12 W to about 16 W, about 12 W to about 18 W, about 12 W to about 20 W, about 14 W to about 16 W, about 14 W to about 18 W, about 14 W to about 20 W, about 16 W to about 18 W, about 16 W to about 20 W, or about 18 W to about 20 W. In some embodiments, the battery has a power of about 0.5 W, about 1 W, about 2 W, about 4 W, about 6 W, about 8 W, about 10 W, about 12 W, about 14 W, about 16 W, about 18 W, or about 20 W. In some embodiments, the battery has a power of at least about 0.5 W, about 1 W, about 2 W, about 4 W, about 6 W, about 8 W, about 10 W, about 12 W, about 14 W, about 16 W, or about 18 W. In some embodiments, the battery has a power of at most about 1 W, about 2 W, about 4 W, about 6 W, about 8 W, about 10 W, about 12 W, about 14 W, about 16 W, about 18 W, or about 20 W.

In some embodiments, the aerial vehicle 100 has a length of about 50 mm to about 400 mm. In some embodiments, the aerial vehicle 100 has a length of about 50 mm to about 100 mm, about 50 mm to about 150 mm, about 50 mm to about 200 mm, about 50 mm to about 250 mm, about 50 mm to about 300 mm, about 50 mm to about 350 mm, about 50 mm to about 400 mm, about 100 mm to about 150 mm, about 100 mm to about 200 mm, about 100 mm to about 250 mm, about 100 mm to about 300 mm, about 100 mm to about 350 mm, about 100 mm to about 400 mm, about 150 mm to about 200 mm, about 150 mm to about 250 mm, about 150 mm to about 300 mm, about 150 mm to about 350 mm, about 150 mm to about 400 mm, about 200 mm to about 250 mm, about 200 mm to about 300 mm, about 200 mm to about 350 mm, about 200 mm to about 400 mm, about 250 mm to about 300 mm, about 250 mm to about 350 mm, about 250 mm to about 400 mm, about 300 mm to about 350 mm, about 300 mm to about 400 mm, or about 350 mm to about 400 mm. In some embodiments, the aerial vehicle 100 has a length of about 50 mm, about 100 mm, about 150 mm, about 200 mm, about 250 mm, about 300 mm, about 350 mm, or about 400 mm. In some embodiments, the aerial vehicle 100 has a length of at least about 50 mm, about 100 mm, about 150 mm, about 200 mm, about 250 mm, about 300 mm, or about 350 mm. In some embodiments, the aerial vehicle 100 has a length of at most about 100 mm, about 150 mm, about 200 mm, about 250 mm, about 300 mm, about 350 mm, or about 400 mm.

In some embodiments, the aerial vehicle 100 has a width of about 50 mm to about 400 mm. In some embodiments, the aerial vehicle 100 has a width of about 50 mm to about 100 mm, about 50 mm to about 150 mm, about 50 mm to about 200 mm, about 50 mm to about 250 mm, about 50 mm to about 300 mm, about 50 mm to about 350 mm, about 50 mm to about 400 mm, about 100 mm to about 150 mm, about 100 mm to about 200 mm, about 100 mm to about 250 mm, about 100 mm to about 300 mm, about 100 mm to about 350 mm, about 100 mm to about 400 mm, about 150 mm to about 200 mm, about 150 mm to about 250 mm, about 150 mm to about 300 mm, about 150 mm to about 350 mm, about 150 mm to about 400 mm, about 200 mm to about 250 mm, about 200 mm to about 300 mm, about 200 mm to about 350 mm, about 200 mm to about 400 mm, about 250 mm to about 300 mm, about 250 mm to about 350 mm, about 250 mm to about 400 mm, about 300 mm to about 350 mm, about 300 mm to about 400 mm, or about 350 mm to about 400 mm. In some embodiments, the aerial vehicle 100 has a width of about 50 mm, about 100 mm, about 150 mm, about 200 mm, about 250 mm, about 300 mm, about 350 mm, or about 400 mm. In some embodiments, the aerial vehicle 100 has a width of at least about 50 mm, about 100 mm, about 150 mm, about 200 mm, about 250 mm, about 300 mm, or about 350 mm. In some embodiments, the aerial vehicle 100 has a width of at most about 100 mm, about 150 mm, about 200 mm, about 250 mm, about 300 mm, about 350 mm, or about 400 mm.

In some embodiments, the aerial vehicle 100 has a height of about 30 mm to about 140 mm. In some embodiments, the aerial vehicle 100 has a height of about 30 mm to about 40 mm, about 30 mm to about 50 mm, about 30 mm to about 60 mm, about 30 mm to about 70 mm, about 30 mm to about 80 mm, about 30 mm to about 90 mm, about 30 mm to about 100 mm, about 30 mm to about 120 mm, about 30 mm to about 140 mm, about 40 mm to about 50 mm, about 40 mm to about 60 mm, about 40 mm to about 70 mm, about 40 mm to about 80 mm, about 40 mm to about 90 mm, about 40 mm to about 100 mm, about 40 mm to about 120 mm, about 40 mm to about 140 mm, about 50 mm to about 60 mm, about 50 mm to about 70 mm, about 50 mm to about 80 mm, about 50 mm to about 90 mm, about 50 mm to about 100 mm, about 50 mm to about 120 mm, about 50 mm to about 140 mm, about 60 mm to about 70 mm, about 60 mm to about 80 mm, about 60 mm to about 90 mm, about 60 mm to about 100 mm, about 60 mm to about 120 mm, about 60 mm to about 140 mm, about 70 mm to about 80 mm, about 70 mm to about 90 mm, about 70 mm to about 100 mm, about 70 mm to about 120 mm, about 70 mm to about 140 mm, about 80 mm to about 90 mm, about 80 mm to about 100 mm, about 80 mm to about 120 mm, about 80 mm to about 140 mm, about 90 mm to about 100 mm, about 90 mm to about 120 mm, about 90 mm to about 140 mm, about 100 mm to about 120 mm, about 100 mm to about 140 mm, or about 120 mm to about 140 mm. In some embodiments, the aerial vehicle 100 has a height of about 30 mm, about 40 mm, about 50 mm, about 60 mm, about 70 mm, about 80 mm, about 90 mm, about 100 mm, about 120 mm, or about 140 mm. In some embodiments, the aerial vehicle 100 has a height of at least about 30 mm, about 40 mm, about 50 mm, about 60 mm, about 70 mm, about 80 mm, about 90 mm, about 100 mm, or about 120 mm. In some embodiments, the aerial vehicle 100 has a height of at most about 40 mm, about 50 mm, about 60 mm, about 70 mm, about 80 mm, about 90 mm, about 100 mm, about 120 mm, or about 140 mm.

In some embodiments, the wings have a length of about 35 mm to about 140 mm. In some embodiments, the wings have a length of about 35 mm to about 40 mm, about 35 mm to about 45 mm, about 35 mm to about 50 mm, about 35 mm to about 60 mm, about 35 mm to about 70 mm, about 35 mm to about 80 mm, about 35 mm to about 90 mm, about 35 mm to about 100 mm, about 35 mm to about 120 mm, about 35 mm to about 140 mm, about 40 mm to about 45 mm, about 40 mm to about 50 mm, about 40 mm to about 60 mm, about 40 mm to about 70 mm, about 40 mm to about 80 mm, about 40 mm to about 90 mm, about 40 mm to about 100 mm, about 40 mm to about 120 mm, about 40 mm to about 140 mm, about 45 mm to about 50 mm, about 45 mm to about 60 mm, about 45 mm to about 70 mm, about 45 mm to about 80 mm, about 45 mm to about 90 mm, about 45 mm to about 100 mm, about 45 mm to about 120 mm, about 45 mm to about 140 mm, about 50 mm to about 60 mm, about 50 mm to about 70 mm, about 50 mm to about 80 mm, about 50 mm to about 90 mm, about 50 mm to about 100 mm, about 50 mm to about 120 mm, about 50 mm to about 140 mm, about 60 mm to about 70 mm, about 60 mm to about 80 mm, about 60 mm to about 90 mm, about 60 mm to about 100 mm, about 60 mm to about 120 mm, about 60 mm to about 140 mm, about 70 mm to about 80 mm, about 70 mm to about 90 mm, about 70 mm to about 100 mm, about 70 mm to about 120 mm, about 70 mm to about 140 mm, about 80 mm to about 90 mm, about 80 mm to about 100 mm, about 80 mm to about 120 mm, about 80 mm to about 140 mm, about 90 mm to about 100 mm, about 90 mm to about 120 mm, about 90 mm to about 140 mm, about 100 mm to about 120 mm, about 100 mm to about 140 mm, or about 120 mm to about 140 mm. In some embodiments, the wings have a length of about 35 mm, about 40 mm, about 45 mm, about 50 mm, about 60 mm, about 70 mm, about 80 mm, about 90 mm, about 100 mm, about 120 mm, or about 140 mm. In some embodiments, the wings have a length of at least about 35 mm, about 40 mm, about 45 mm, about 50 mm, about 60 mm, about 70 mm, about 80 mm, about 90 mm, about 100 mm, or about 120 mm. In some embodiments, the wings have a length of at most about 40 mm, about 45 mm, about 50 mm, about 60 mm, about 70 mm, about 80 mm, about 90 mm, about 100 mm, about 120 mm, or about 140 mm.

In some embodiments, the aerial vehicle 100 has a weight of about 50 g to about 200 g. In some embodiments, the aerial vehicle 100 has a weight of about 50 g to about 60 g, about 50 g to about 70 g, about 50 g to about 80 g, about 50 g to about 90 g, about 50 g to about 100 g, about 50 g to about 120 g, about 50 g to about 140 g, about 50 g to about 160 g, about 50 g to about 180 g, about 50 g to about 200 g, about 60 g to about 70 g, about 60 g to about 80 g, about 60 g to about 90 g, about 60 g to about 100 g, about 60 g to about 120 g, about 60 g to about 140 g, about 60 g to about 160 g, about 60 g to about 180 g, about 60 g to about 200 g, about 70 g to about 80 g, about 70 g to about 90 g, about 70 g to about 100 g, about 70 g to about 120 g, about 70 g to about 140 g, about 70 g to about 160 g, about 70 g to about 180 g, about 70 g to about 200 g, about 80 g to about 90 g, about 80 g to about 100 g, about 80 g to about 120 g, about 80 g to about 140 g, about 80 g to about 160 g, about 80 g to about 180 g, about 80 g to about 200 g, about 90 g to about 100 g, about 90 g to about 120 g, about 90 g to about 140 g, about 90 g to about 160 g, about 90 g to about 180 g, about 90 g to about 200 g, about 100 g to about 120 g, about 100 g to about 140 g, about 100 g to about 160 g, about 100 g to about 180 g, about 100 g to about 200 g, about 120 g to about 140 g, about 120 g to about 160 g, about 120 g to about 180 g, about 120 g to about 200 g, about 140 g to about 160 g, about 140 g to about 180 g, about 140 g to about 200 g, about 160 g to about 180 g, about 160 g to about 200 g, or about 180 g to about 200 g. In some embodiments, the aerial vehicle 100 has a weight of about 50 g, about 60 g, about 70 g, about 80 g, about 90 g, about 100 g, about 120 g, about 140 g, about 160 g, about 180 g, or about 200 g. In some embodiments, the aerial vehicle 100 has a weight of at least about 50 g, about 60 g, about 70 g, about 80 g, about 90 g, about 100 g, about 120 g, about 140 g, about 160 g, or about 180 g. In some embodiments, the aerial vehicle 100 has a weight of at most about 60 g, about 70 g, about 80 g, about 90 g, about 100 g, about 120 g, about 140 g, about 160 g, about 180 g, or about 200 g.

### Aerial Vehicles

Another aspect provided herein, per FIGS. 1-6 is a modular aerial vehicle 100 comprising a hull 120 and two or more modular wing units 110. In some embodiments, each modular wing unit 110 comprises a single wing 116 and an actuator 111. In some embodiments, the single wing 116 is configured to generate lift, thrust, or both via a flapping. In some embodiments, the single wing 116 is actuated by the actuator 111 in a flapping motion. In some embodiments, the actuator 111 actuates the single wing 116 in the flapping motion to propel the hull 120.

### Computing System

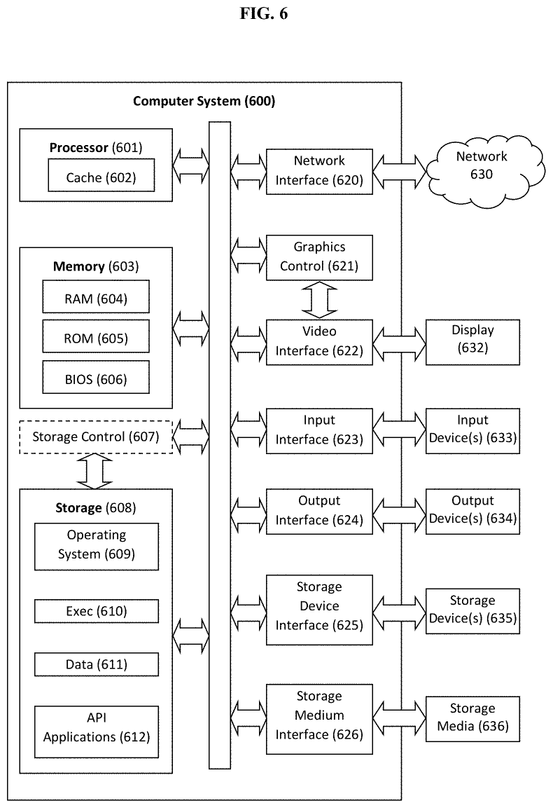

Referring to FIG. 6, a block diagram is shown depicting an exemplary machine that includes a computer system 600 (e.g., a processing or computing system) within which a set of instructions can execute for causing a device to perform or execute any one or more of the aspects and/or methodologies for static code scheduling of the present disclosure. The components in FIG. 6 are examples only and do not limit the scope of use or functionality of any hardware, software, embedded logic component, or a combination of two or more such components implementing particular embodiments.

Computer system 600 may include one or more processors 601, a memory 603, and a storage 608 that communicate with each other, and with other components, via a bus 640. The bus 640 may also link a display 632, one or more input devices 633 (which may, for example, include a keypad, a keyboard, a mouse, a stylus, etc.), one or more output devices 634, one or more storage devices 635, and various tangible storage media 636. All of these elements may interface directly or via one or more interfaces or adaptors to the bus 640. For instance, the various tangible storage media 636 can interface with the bus 640 via storage medium interface 626. Computer system 600 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 600 includes one or more processor(s) 601 (e.g., central processing units (CPUs) or general purpose graphics processing units (GPGPUs)) that carry out functions. Processor(s) 601 optionally contains a cache memory unit 602 for temporary local storage of instructions, data, or computer addresses. Processor(s) 601 are configured to assist in execution of computer readable instructions. Computer system 600 may provide functionality for the components depicted in FIG. 6 as a result of the processor(s) 601 executing non-transitory, processor-executable instructions embodied in one or more tangible computer-readable storage media, such as memory 603, storage 608, storage devices 635, and/or storage medium 636. The computer-readable media may store software that implements particular embodiments, and processor(s) 601 may execute the software. Memory 603 may read the software from one or more other computer-readable media (such as mass storage device(s) 635, 636) or from one or more other sources through a suitable interface, such as network interface 620. The software may cause processor(s) 601 to carry out one or more processes or one or more steps of one or more processes described or illustrated herein. Carrying out such processes or steps may include defining data structures stored in memory 603 and modifying the data structures as directed by the software.

The memory 603 may include various components (e.g., machine readable media) including, but not limited to, a random access memory component (e.g., RAM 604) (e.g., static RAM (SRAM), dynamic RAM (DRAM), ferroelectric random access memory (FRAM), phase-change random access memory (PRAM), etc.), a read-only memory component (e.g., ROM 605), and any combinations thereof. ROM 605 may act to communicate data and instructions unidirectionally to processor(s) 601, and RAM 604 may act to communicate data and instructions bidirectionally with processor(s) 601. ROM 605 and RAM 604 may include any suitable tangible computer-readable media described below. In one example, a basic input/output system 606 (BIOS), including basic routines that help to transfer information between elements within computer system 600, such as during start-up, may be stored in the memory 603.

Fixed storage 608 is connected bidirectionally to processor(s) 601, optionally through storage control unit 607. Fixed storage 608 provides additional data storage capacity and may also include any suitable tangible computer-readable media described herein. Storage 608 may be used to store operating system 609, executable(s) 610, data 611, applications 612 (application programs), and the like. Storage 608 can also include an optical disk drive, a solid-state memory device (e.g., flash-based systems), or a combination of any of the above. Information in storage 608 may, in appropriate cases, be incorporated as virtual memory in memory 603.

In one example, storage device(s) 635 may be removably interfaced with computer system 600 (e.g., via an external port connector (not shown)) via a storage device interface 625. Particularly, storage device(s) 635 and an associated machine-readable medium may provide non-volatile and/or volatile storage of machine-readable instructions, data structures, program modules, and/or other data for the computer system 600. In one example, software may reside, completely or partially, within a machine-readable medium on storage device(s) 635. In another example, software may reside, completely or partially, within processor(s) 601.

Bus 640 connects a wide variety of subsystems. Herein, reference to a bus may encompass one or more digital signal lines serving a common function, where appropriate. Bus 640 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 600 may also include an input device 633. In one example, a user of computer system 600 may enter commands and/or other information into computer system 600 via input device(s) 633. Examples of an input device(s) 633 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 633 may be interfaced to bus 640 via any of a variety of input interfaces 623 (e.g., input interface 623) including, but not limited to, serial, parallel, game port, USB, FIREWIRE, THUNDERBOLT, or any combination of the above.

In particular embodiments, when computer system 600 is connected to network 630, computer system 600 may communicate with other devices, specifically mobile devices and enterprise systems, distributed computing systems, cloud storage systems, cloud computing systems, and the like, connected to network 630. Communications to and from computer system 600 may be sent through network interface 620. For example, network interface 620 may receive incoming communications (such as requests or responses from other devices) in the form of one or more packets (such as Internet Protocol (IP) packets) from network 630, and computer system 600 may store the incoming communications in memory 603 for processing. Computer system 600 may similarly store outgoing communications (such as requests or responses to other devices) in the form of one or more packets in memory 603 and communicated to network 630 from network interface 620. Processor(s) 601 may access these communication packets stored in memory 603 for processing.

Examples of the network interface 620 include, but are not limited to, a network interface card, a modem, and any combination thereof. Examples of a network 630 or network segment 630 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 630, may employ a wired and/or a wireless mode of communication. In general, any network topology may be used.

Information and data can be displayed through a display 632. Examples of a display 632 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 632 can interface to the processor(s) 601, memory 603, and fixed storage 608, as well as other devices, such as input device(s) 633, via the bus 640. The display 632 is linked to the bus 640 via a video interface 622, and transport of data between the display 632 and the bus 640 can be controlled via the graphics control 621. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 632, computer system 600 may include one or more other peripheral output devices 634 including, but not limited to, an audio speaker, a printer, a storage device, and any combinations thereof. Such peripheral output devices may be connected to the bus 640 via an output interface 624. Examples of an output interface 624 include, but are not limited to, a serial port, a parallel connection, a USB port, a FIREWIRE port, a THUNDERBOLT port, and any combinations thereof.

In addition or as an alternative, computer system 600 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB.NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Terms and Definitions

Unless otherwise defined, all technical terms used herein have the same meaning as commonly understood by one of ordinary skill in the art to which this disclosure belongs.

As used herein, the term “roll” refers to rotation about an axis between the forward and reverse directions of a vehicle.

As used herein, the term “pitch” refers to rotation about an axis parallel to the earth tangential and perpendicular to the axis between the forward and reverse directions of a vehicle.

As used herein, the term “yaw” refers to rotation about an axis perpendicular to the earth tangential and perpendicular to the axis between the forward and reverse directions of a vehicle.

As used herein, the term “flapping velocity” refers to a maximum velocity of a point on a wing, or a maximum rotational velocity of a point on the wing.

As used herein, the term “flapping amplitude” refers to a maximum displacement of a point on a wing, or a maximum rotational displacement of a point on the wing.

As used herein, the term “flapping angle” refers to a maximum angle between a plane defined by the stroke of the wing and the surface of the wing.

As used herein, the term “oscillating motion” refers to a series of repetitive subsequent motions in two or more opposite directions.

As used herein, the term “continuous rotation” refers to a repetitive motion in only a single direction.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

1-22. (canceled)

23. An aerial vehicle comprising:
(a) a hull; and
(b) two or more modular wing units, each modular wing unit releasably and operably coupled to the hull and comprising:
(i) a single wing configured to generate lift, thrust, or both via a flapping motion; and
(ii) an actuator actuating the single wing in the flapping motion;
wherein each of the two or more modular wing units is individually controllable to alter a flight characteristic of the aerial vehicle.

24. The aerial vehicle of claim 23, wherein each of the two or more modular wing units is pivotable about the hull.

25. The aerial vehicle of claim 23, wherein the two or more modular wing units releasably and operably couple to a top portion, a bottom portion, a front portion, a rear portion, a side portion, or any combination thereof of the hull.

26. The aerial vehicle of claim 23, wherein the two or more modular wing units releasably and operably couple to the hull without the use of tools.

27. The aerial vehicle of claim 23, wherein the two or more modular wing units releasably and operably couple to the hull in less than about 10 minutes.

28. (canceled)

29. The aerial vehicle of claim 23, wherein the actuator is configured to individually actuate and controls only one single wing.

30. (canceled)

31. (canceled)

32. (canceled)

33. (canceled)

34. (canceled)

35. (canceled)

36. The aerial vehicle of claim 23, wherein the flapping motion is at or near a resonance frequency of the single wing.

37. (canceled)

38. (canceled)

39. (canceled)

40. (canceled)

41. The aerial vehicle of claim 23, wherein the modular wing unit further comprises an energy recovery unit coupled to the actuator, the single wing, or both,

42. The aerial vehicle of claim 41, wherein the energy recovery unit is configured to impart a returning force on the single wing towards a center point of the flapping motion.

43. (canceled)

44. The aerial vehicle of claim 23, further comprising a controller configured to direct the actuator of each of the two or more modular units.

45. An aerial vehicle kit comprising:
(a) a hull;
(b) two or more modular wing units, each modular wing unit comprising:
(i) an actuator; and
(ii) a wing configured to be actuated by the actuator in a flapping motion to propel the hull; and
(c) a flight controller configured to individually control the actuator of each of the two or more modular wing units;
wherein the two or more modular wing units are configured to releasably and operably couple to the hull.

46. The kit of claim 45, wherein each of the two or more modular wing units is pivotable about the hull.

47. The kit of claim 45, wherein the two or more modular wing units are configured to releasably and operably couple to a top portion, a bottom portion, a front portion, a rear portion, a side portion, or any combination thereof of the hull.

48. The kit of claim 45, wherein the two or more modular wing units are configured to releasably and operably couple to the hull without the use of tools.

49. The kit of claim 45, wherein the two or more modular wing units are configured to releasably and operably couple to the hull in less than about 10 minutes.

50. (canceled)

51. The kit of claim 45, wherein the actuator is configured to individually actuate and control only one single wing.

52. (canceled)

53. (canceled)

54. (canceled)

55. (canceled)

56. (canceled)

57. (canceled)

58. The kit of claim 45, wherein the flapping motion is at or near a resonance frequency of the single wing.

59. (canceled)

60. (canceled)

61. (canceled)

62. The kit of claim 45, wherein the modular wing unit further comprises an energy recovery unit coupled to the actuator, the single wing, or both,

63. The kit of claim 62, wherein the energy recovery unit is configured to impart a returning force on the single wing towards a center point of the flapping motion.

64. (canceled)

65. The kit of claim 45, further comprising a controller configured to direct the actuator of each of the two or more modular units.

66. The kit of claim 45, wherein the flight controller is configured to individually control the motors of the two or more modular wing units in:
(a) an in-phase wing flapping mode;
(b) an out-of-phase wing flapping mode;
(c) a sequential wing flapping mode;
(d) a periodic in-phase and out-of-phase flapping mode; or
(e) any combination thereof

67-92. (canceled)
